(19) United States
(12) Patent Application Publication
(10) Pub. No.: US 2026/0125939 A1
(43) Pub. Date: May 7, 2026

(54) Automation for Mid-size Cabinet Doors and Drawers

(71) Applicant: Albert Michael David, Orlando, FL (US)

(72) Inventor: Albert Michael David, Orlando, FL (US)

(21) Appl. No.: 18/934,681

(22) Filed: Nov. 1, 2024

(51) Int. Cl. E05F 1/00; E05F 15/603

(52) U.S. Cl. CPC E05F 1/002; A47B 88/453; E05F 15/603; E05F 15/70

(57) ABSTRACT

A combined electronic and mechanical system capable of safely opening and closing a combination of multiple doors and drawers (alternatively, a device) enclosed in one or more cabinet bodies. A computer processor receives a signal from a (typically non-touch) human interface component and then activates a servo post to rotate a given number of degrees. The rods connecting the rotating servo post to the device cause the device to move in the desired direction. The computer processor implements safety controls such as ensuring vertical drawers do not cause the cabinet to tip and that doors close safely. Lastly, the system maintains device state even when manually operated.

### BACKGROUND OF THE INVENTION

For purposes of this filing, the term “device” refers to a door or drawer enclosed in a cabinet body. The term “Mid-size” refers to drawers and doors that are typically found in household kitchens, bathrooms, bedrooms and garages. Excluded are tray cabinets such as used for small medical supplies and small hardware.

Multiple inventions exist that automate, via a computer processor, the opening of a device. Searching the patent libraries, most such inventions are directed at locking or unlocking cabinet devices or operating vending devices. Cabinet device opening/closing systems are not designed to be field installable with common household tools. Some cabinet hardware assists with device closing such as soft-close drawers and spring-loaded door hinges. All devices described above require touch activation—a problem when hands are full or grimy. Many drawer cabinets become unsafe when more than one drawer is opened. When doors are slammed, the door and/or its cabinet become weekend. Hands can get pinched in a door or drawer manually operated.

The invention addresses a market appetite for touch-free automation wherever physically practical, safe, and affordable. This invention automates opening and closing multiple devices enclosed in one or more cabinets. The invention can be integrated and installed efficiently at the cabinet factory. It can be delivered as a package and installed on-site into existing cabinetry without degradation of cabinet aesthetics by anyone skilled with common household tools.

### SUMMARY OF THE INVENTION

For purposes of this summary, the term ‘device’ refers to a single upright door or horizontal drawer contained within a cabinet consisting of one or more doors and/or drawers. The device(s) are not part of the invention. The doors, drawers and cabinets may be made of metal, plastic, wood or other material that allows the doors and drawers to move with minimal friction. For doors, hinges or posts are adequate for minimum friction if there is no securing component such as a magnet, clamp or latch. For drawers, glides such as ball bearings or rollers in the center or on the sides are satisfactory. Drawer mechanisms that use springs or pistons, commonly known as ‘soft close’ drawers are not suitable.

The following statements describes the requirements for light-duty cabinet doors and drawers:

Installable at factory using an efficient, repeatable, and integrated cabinet production process

Installable on an existing cabinet at a local site without the requirement for specialty tools. A measuring device, a screwdriver set and a drill capable of drilling metal, wood or plastic cabinetry should be sufficient tooling

Upgradable at the local site including upgrades to physical components as well as the software component

Manually operable without damage to the devices or loss of software awareness of device state or position

Void of sensors to determine device state or position.

### BRIEF DESCRIPTION OF DRAWINGS

FIG. 1 diagrams the electrical and electronic components of the invention. Included are the multi-port processor (P#1), a stimulus (P#2), the power source (P#3), a servo (P#4).

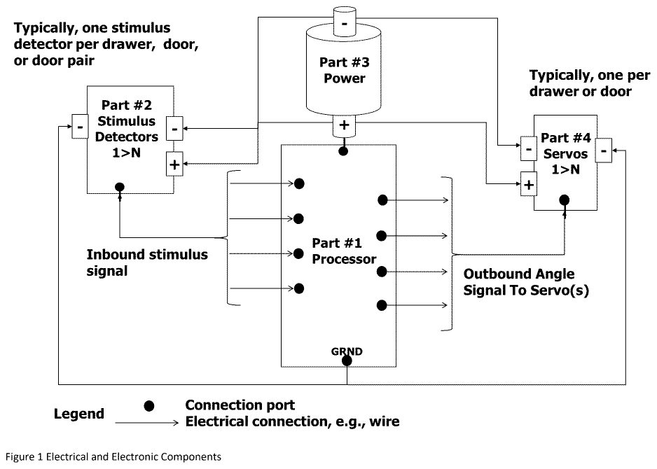

FIG. 2 illustrates the drawer opening and closing assembly components. Included are the drawer bottom underside (P#11), the cabinet sidewall (P#16), a servo (P#4), the servo to rod connector (P#5 and P #15), two flat rods (P#6 and P#7), rod 1<>2 connector pin (P#8), drawer<>rod connector pin (P #10), optional magnets (P#9) for rod support if needed, and optional coated metal plate (P #19) used for non-metalic drawers.

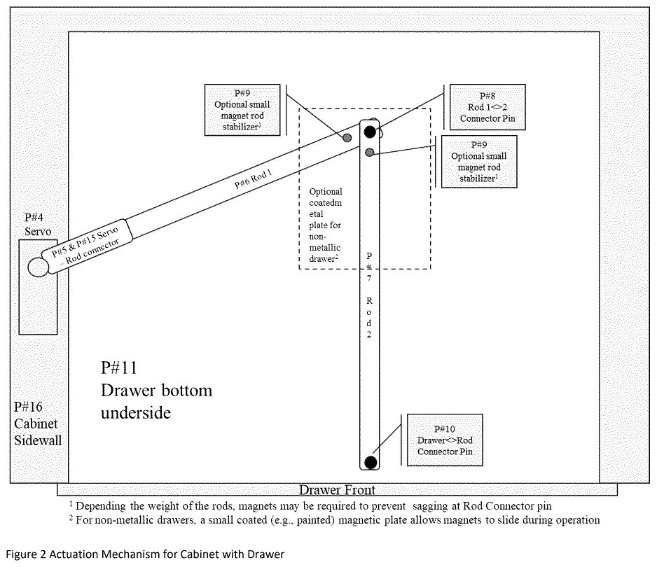

FIG. 3 illustrates door opening and closing assembly components. Included are the cabinet left and right doors (P#17), the cabinet frame (P#18), left and right servos (P#4), left and right servo slider pipes (P#12 and P#15), left and right slider rods (P#13) and left and right door<>slider L-connectors (P#14). Note that if the pipe is fully enclosed, e.g., round, then the pipe cap (P#15) is not required.

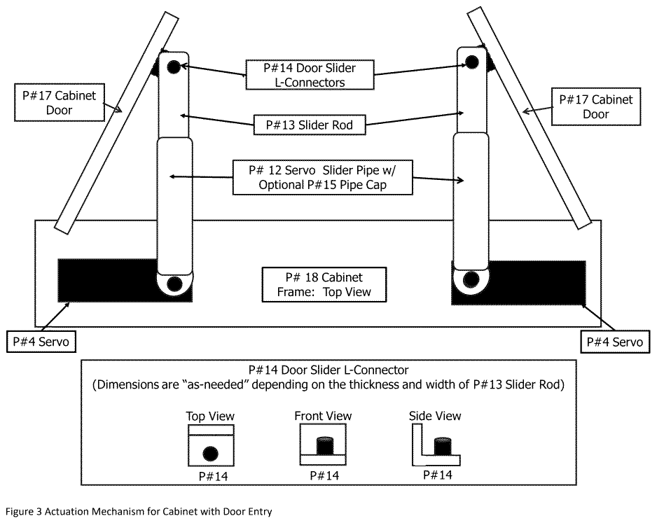

FIG. 4 illustrates the inside of the drawer servo to rod connector (P#5) highlighting the pin that secures the flat metal rod 1 (P#6) to prevent the rod from sliding.

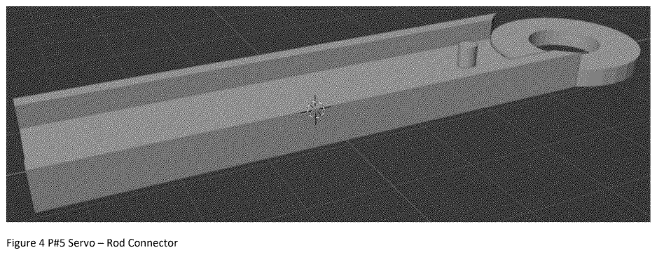

FIG. 5 illustrates top and side views of the door slider assembly. Included are the servo slider pipe (P#12 and P#15), the slider rod (P#13) and the door slider L-connector (P#14).

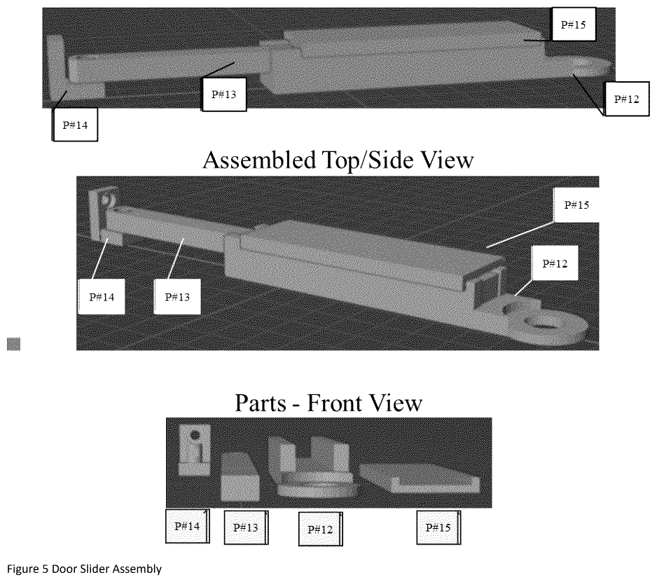

### DETAILED DESCRIPTION OF THE INVENTION

For purposes of this description, the term ‘device’ refers to a single upright door or horizontal drawer contained within a cabinet consisting of one or more doors and/or drawers. The device(s) are not part of the invention. The doors, drawers and cabinets may be made of metal, plastic, wood or other material that allows the doors and drawers to move with minimal friction. For doors, hinges or posts are adequate for minimum friction if there is no securing component such as a magnet, clamp or latch. For drawers, glides such as ball bearings or rollers in the center or on the sides are satisfactory. Drawer mechanisms that use springs or pistons, commonly known as ‘soft close’ drawers are not suitable.

The invention described in this section meets the requirements detailed in the Summary section. Electronic opening and closing of light-duty doors and drawers, contained requires five basic components: 1) an electronic processor (P#1) capable of receiving a stimulus signal, activating a servo, determining current state of the device, and establishing safety controls to protect the devices and the user; 2) one or more stimulus detectors (P#2) that instructs the processor to take a requested action and stimulated by human interaction, e.g., voice, light, radio, wi-fi, Bluetooth, sound, sonar; 3) electrical power (P#3) e.g., in the form of a battery, AC/DC adapter, or solar cell; 4) one or more servos (P#4) attached to the cabinet frame with sufficient power to move (in opposite directions) an armature attached between the servo and device, with awareness of its current position whether moved electronically or manually; and, 5) one or more armatures per server/device, depending on weight and friction of device, capable of adjusting its length in response to movement of the device.

The actuation component for doors differs from the actuation component for drawers.

### Door Actuation Assembly

Each door of a cabinet is assumed to be attached to the cabinet via one or more hinges or via a post at the top and bottom of the door. The actuation assembly is comprised of 4 parts: 1) a pipe (P#12 and P#15) capable of securely attaching to a servo post, able to securely enclose a rod that slides smoothly back and forth within the pipe, and of sufficient length to contain the rod when the door is fully open and fully closed; 2) a rod (P#13) capable of securely sliding smoothly back and forth within the pipe, and of sufficient length to maintain stability within the pipe when the door is fully open and fully closed; 3) a connector capable of securely interfacing the rod to the door without impeding the movement of the rod as the door opens or closes; and, 4) a servo (P#4) to activate the motion of the door. The vertical placement of the servo (P #4) and slider assembly (P#12,15,13) is not relevant so long as 1) the servo post rotates horizontally and level with the L-connector (P#14) and 2) the cabinet frame does not interfere with the slider.

### Drawer Actuation Assembly

A cabinet may contain multiple drawers. The invention requires a cabinet wall capable of supporting each servo attached. The type and thickness of the cabinet wall determines the best method to attach the server, e.g., metal screws, wood screws, nut and bolt. The design of the cabinet must provide adequate space such that the top of the servo (P#4) aligns with the bottom of the drawer. The space for the servo (P#4) can be between the cabinet wall and the drawer sidewall or between top of a lower drawer sidewall and the bottom of the target drawer (P#11) sidewall. In other words, no part of the drawer can contact any part of the servo. The space required depends on the thickness and height of the servo. Drawers of height less than the height of the servo complicates the installation though not impossible.

The two rods (P#6 and P#7) when joined with the rod 1<>2 connector pin (P#8) form an rotatable joint. The servo rod connector (P#5 and P#15) secures the end of rod 1 (P#6) to the servo rotatable post. The drawer<>rod connector pin (P#10) joins rod 2 (P#7) to the drawer bottom. The drawer<>rod connector pin (P#10) is best located in the front center of the drawer bottom. The drawer<>rod connector pin (P#10) can take multiple forms such as nut and bolt or plastic snaps. Two considerations are to be considered when determining the length of rod 1 (P#6) and rod 2 (P#7): 1) the angle of rod 1 relative to the servo and 2) the length of the drawer. The servo in this type of assembly is strongest as 90°±35°or 65°<>125° relative to the long side of the servo. Given the constraint of the angle range, the length of the two rods must be sufficient to fully extend the drawer. As noted in the Summary section, long but narrow drawers can be challenging if sufficient room beyond the width of the drawer is not available. Typical tool, kitchen, bath and clothing drawers require rods of a length that cause sagging where rod1<>2 is located. The simple solution is to place one or two small magnets between the rods and either the metal drawer bottom (P#11) or the optional coated metal plate (P#19) for non-metallic drawers. The coating ensures that magnets slide along the metal plate while remaining stationary to the rods.

### The Processor

Doors: 1 or more doors; overlapping; tend to move quickly; 2-stage, non-slamming vs small increments; initializing and resetting

Drawers: only 1 drawer in a vertical set may be open at one time. Drawers open and close at servo speed. If weight or friction strains the servo 1) a more powerful servo may be used or a second servo and actuation assembly may be installed.

Remembering state: The servo is inherently aware of its current position enabling the initialization to a closed position on powerup and the manual manipulation of the drawer without loss of state.

### The Stimulus

One or more stimuli can activate a device or set of devices depending on the logic embedded in the processor.

Responding to Stimuli: A stimulus (e.g., optical, sonar, touch, speech, radio, wi-fi, Bluetooth, button, etc) transmits a signal the processor that, in turn, detects the state of associated one or more devices. Conditions that reflect a safety concern, e.g., a different drawer already open, cause the processor to correct the unsafe condition before invoking the action on the associated devices. The processor also interprets repeated stimulus to perform variants of an open/close function such as a partial open or close action or change of speed.

### Wiring

Cabinets that have sufficient space to contain the servos will have more than adequate space to safely and securely route the wiring between the stimulus (P#2) and the processor (P#1) and between the processor (P#1) and the servo (P#4). The processor can be attached inside the cabinet frame to the top, bottom, side or back. If space inside the frame is insufficient for the processor, it can be attached outside the frame and wired through a hole to the servos (P#4). If placed outside the cabinet frame, consider the aesthetics and risk of physical damage from movement. The stimulus is always attached outside the frame accessible to human interface. With rare exceptions of signal strength, a stimulus may be separated from the frame using longer wire or radio/wi-fi/Bluetooth connections.

1. A system of electronic devices and hardware for opening and closing cabinet drawers and doors comprising:
an electrically powered processor, aka programmable logic controller
a motorized servo affixed to the cabinet body that is processor controlled, electrically powered with a rotating post for which circular movement is measurable in degrees to actuate the opening and closing
wiring that provides electrical power from a power source to the processor and from the processor to the servos
rods used to connect a servo to a device and transfer the motion of the servo to the motion of the device
rods used for doors that are connected to a single servo post at one end and connects to the door via a pin located on an L-connector
pins that join a rod to an L-connector in the case of a door, or joins two rods in the case of a drawer
an L-connector used for a door to connect a rod to a door while allowing the rod to swivel on the L-connector
magnets that are optionally used to ensure drawer rods maintain a level state beneath the underside of a drawer
a metal plate optionally used on the underside of a non-metallic drawer bottom to ensure drawer rods maintain a level state beneath the underside of a drawer.

2. The system according to claim 1, wherein the processor receives a signal from one stimulus, evaluates the state of device(s) corresponding to the stimulus, determines the degree, aka angle, to rotate servo(s), and actuates the servo(s) to rotate to the determined degree.

3. The system according to claim 1, wherein two rotating rods joined by a pin connect at one end to a servo and at another end to a drawer, provide forward and backward motion of a drawer within the body of a cabinet.

4. The system according to claim 2, wherein a servo connected by wire and controlled by the processor, rotate a given number of degrees to cause the rotating rods to move a drawer forward and backward.

5. The system according to claim 2, wherein a stimulus corresponding to one or more devices transmits signals to the processor to actuate the corresponding devices plus any other devices deemed essential to safe operation within a cabinet of devices.

6. The system according to claim 1, wherein: two rods are connected by first pin at a position determined to suitable to fully move a drawer to both open and closed positions and are free to rotate at the position of the first pin; the first rod opposite end of the first pin is firmly connected to a servo rotating post; the second rod is connected to a drawer by a second pin also free to rotate.

7. The system according to claim 1, wherein: a pipe is connected to a servo rotating post; a rod freely sliding inside the pipe with a hole at one end that rotates around the pin of an L-shaped connector, an L-shaped connector containing a pin inserted into the hole in the rod, and allows free rotation of the rod, and is firmly affixed to a door; the combined length of the pipe and rod are suitable to extend and retract the door to a fully opened and closed position, respectively.
